(19) United States
(12) Patent Application Publication
(10) Pub. No.: US 2024/0406925 A1
(43) Pub. Date: Dec. 5, 2024

(54) ANTENNAS ON A FLYING PLATFORM

(71) Applicant: SOLUTIONS HUMANITAS INC., Montréal (CA)

(72) Inventors: Abdo SHABAH, Montréal (CA); Maroua BEN ATTIA, Montréal (CA); Chuan PHAM, Montréal (CA)

(21) Appl. No.: 18/732,163

(22) Filed: Jun. 3, 2024

Related U.S. Application Data
(60) Provisional application No. 63/506,041, filed on Jun. 2, 2023.

(51) Int. Cl. H04W 64/00; H01Q 3/00; H04B 7/0413; H04W 16/28; H04W 84/06; H04W 88/08

(52) U.S. Cl. CPC H04W 64/003; H01Q 3/005; H04B 7/0413; H04W 16/28; H04W 84/06; H04W 88/085

(57) ABSTRACT

A distributed antenna system comprising a plurality of flying platforms, a plurality of antennas and an orchestration mechanism for dynamically positioning the one or more antennas on the plurality of flying platforms. A flying platform comprising an internal space having one or more internal pockets filled with lighter-than-air gas, an external surface, one or more antennas and a clipping mechanism for selectively positioning the one or more antennas within the internal space and/or on the external surface. A method comprising selectively positioning multiple antennas on a plurality of flying platforms and, upon trigger, dynamically repositioning the one or more antennas on the plurality of flying platforms considering transmission and reception of signals thereby.

### PRIORITY STATEMENT

This non-provisional patent application claims priority based upon the prior U.S provisional patent application entitled “ANTENNAS ON A FLYING PLATFORM”, application No. 63/506,041, filed on 2023 Jun. 2, in the name of SOLUTIONS HUMANITAS INC., which is herein incorporated by reference in its entirety.

### TECHNICAL FIELD

The present invention relates to a flying telecommunications platform and, more particularly, to an antennas system on a flying telecommunications platform.

### BACKGROUND

High Altitude Platform Systems (HAPS) are the subject of different initiatives to help, for instance, deploy and maintain telecommunications services in zones that are more difficult to reach using traditional deployment technologies. Solutions that have been proposed appear to rely on traditional approaches to antenna management. The present application aims at providing innovative antenna systems.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a distributed antenna system is provided that includes a plurality of flying platforms, a plurality of antennas and an orchestration mechanism for dynamically positioning the one or more antennas on the plurality of flying platforms.

Other embodiments of this aspect include corresponding computer systems, apparatus, and computer programs recorded on one or more computer storage devices, each configured to perform the actions of the methods.

Implementations may include one or more of the following features. The orchestration mechanism may further dynamically position the one or more antennas by: determining a position for each of the one or more antennas, the position being determined relative to one of the plurality of flying platforms and determining relative positions between the plurality of flying platforms. The orchestration mechanism may further determine, upon trigger, a new composition for the plurality of flying platforms, redetermines the position for each of the one or more antennas, the position being determined relative to one of the plurality of flying platforms and redetermines the relative positions between the plurality of flying platforms. The one or more antennas may be selectively positioned on an external surface thereof and/or within an internal volume of the plurality of flying platforms. One or more intelligent reflection surfaces (IRS) may be deployed on one or more of the plurality of flying platforms and the orchestration mechanism may further determine at least one of the position of the one or more antennas and the relative positions between the plurality of flying platforms considering the one or more IRS. The IRS may be selectively positioned on an external surface and/or within an internal volume thereof. The antennas may be configured for one or more of millimeter-wave (mmWave) communication, laser communication, and multiple input-multiple output (MIMO) communication. The orchestration mechanism dynamically may position the one or more antennas on the plurality of flying platforms to configure a distributed 3D MIMO antenna system. Each of the flying platforms may further include a frontend attachment mechanism and a backend attachment mechanism for securing connections therebetween and a channel may be formed between connected flying platforms. Implementations of the described techniques may include hardware, a method or process, or a computer tangible medium.

In one general aspect, a flying platform is provided that includes an internal space having one or more internal pockets filled with lighter-than-air gas, an external surface, one or more antennas and a clipping mechanism for selectively positioning the one or more antennas within the internal space and/or on the external surface. Other embodiments of this aspect include corresponding computer systems, apparatus, and computer programs recorded on one or more computer storage devices, each configured to perform the actions of the methods.

Implementations may include one or more of the following features. The flying platform may include one or more intelligent reflection surfaces (IRS) and an orchestration mechanism that may further determine the position of the one or more antennas considering the one or more IRS. The antennas may be configured for one or more of millimeter-wave (mmWave) communication, laser communication, beamforming and multiple input-multiple output (MIMO) communication. The flying platform may include a frontend attachment mechanism and a backend attachment mechanism for securing connections with other flying platforms, a channel being formed between connected flying platforms. Implementations of the described techniques may include hardware, a method or process, or a computer tangible medium.

In one general aspect, a method is provided that includes selectively positioning multiple antennas on a plurality of flying platforms and, upon trigger, dynamically repositioning the one or more antennas on the plurality of flying platforms considering transmission and reception of signals thereby. Other embodiments of this aspect include corresponding computer systems, apparatus, and computer programs recorded on one or more computer storage devices, each configured to perform the actions of the methods.

Implementations may include one or more of the following features. Dynamically repositioning the one or more antennas may be performed by determining a position for each of the one or more antennas, the position being determined relative to one of the plurality of flying platforms; and determining relative positions between the plurality of flying platforms. The method may include, upon trigger, determining a new composition for the plurality of flying platforms, redetermining the position for each of the one or more antennas, the position being determined relative to one of the plurality of flying platforms and redetermining the relative positions between the plurality of flying platforms. The method may include configuring the antennas for one or more of millimeter-wave (mmWave) communication, beamforming, laser communication and multiple input-multiple output (MIMO) communication. Implementations of the described techniques may include hardware, a method or process, or a computer tangible medium.

### BRIEF DESCRIPTION OF THE DRAWINGS

Further features and exemplary advantages of the present invention will become apparent from the following detailed description, taken in conjunction with the appended drawings, in which:

FIG. 1 is a representation of an exemplary flying platform in accordance with the teachings of the present invention;

FIG. 2 is a representation of exemplary flying platform with antennas in accordance with the teachings of the present invention;

FIG. 3 a representation of chained flying platforms in accordance with the teachings of the present invention;

FIG. 4 is a representation of exemplary antennas within an internal structure of a flying platform in accordance with the teachings of the present invention;

FIG. 5 is a representation of a flying platform formation in accordance with the teachings of the present invention;

FIG. 6 is a representation of a flying platform formation in accordance with the teachings of the present invention;

FIG. 7 is representation of a base station in accordance with the teachings of the present invention;

FIG. 8 is a representation of a flying platform in a different configuration in accordance with the teachings of the present invention;

FIG. 9 is a logical modular representation of an exemplary network node deployed in a system in accordance with the teachings of the present invention;

FIG. 10 is a representation of an exemplary drone in accordance with the teachings of the present invention;

FIG. 11 is a representation of an exemplary drone in accordance with the teachings of the present invention;

FIG. 12 is a representation of an exemplary system in accordance with the teachings of the present invention; and

FIG. 13 is a representation of a drone in accordance with the teachings of the present invention.

### DETAILED DESCRIPTION

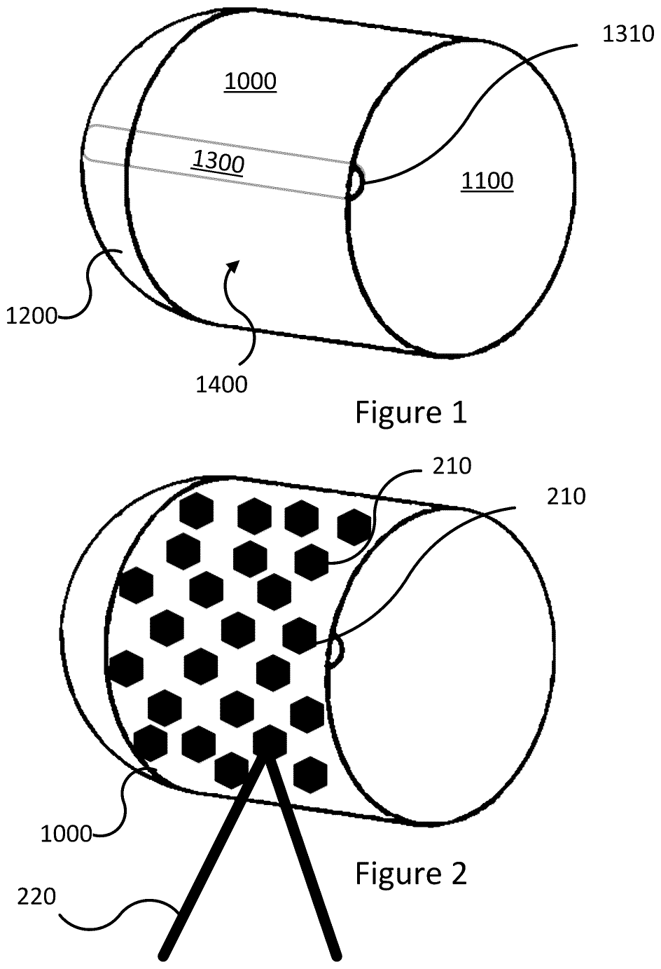

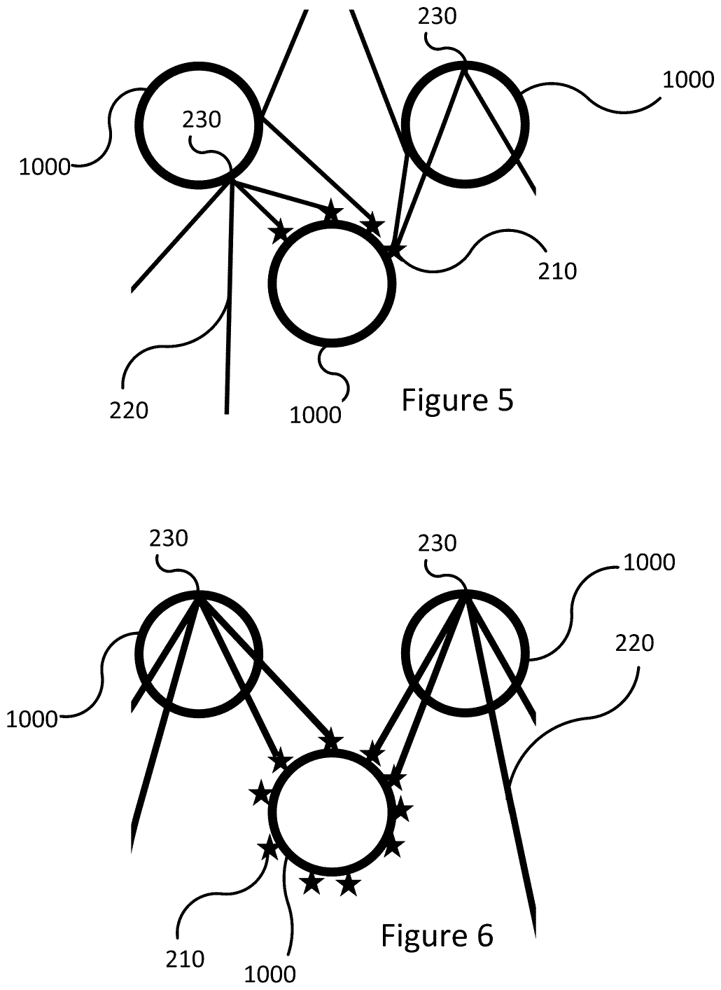

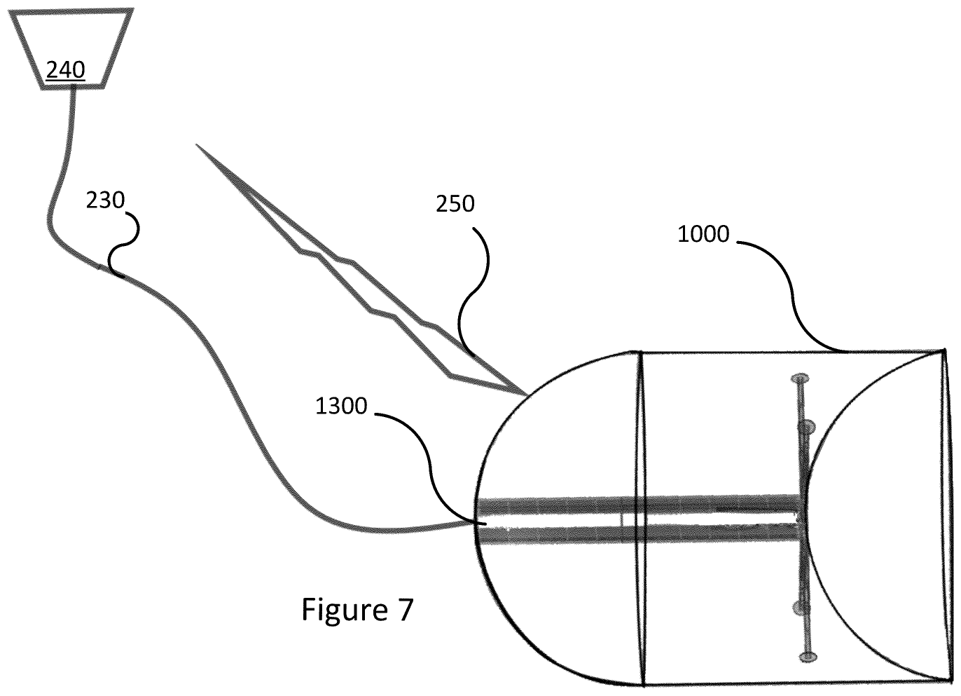

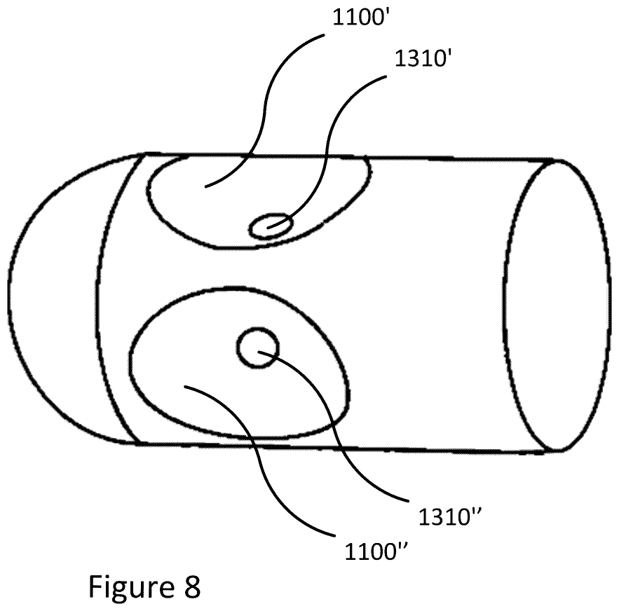

Reference is now made concurrently to FIGS. 1 to 13. The present disclosure outlines design solutions for one or more antenna systems deployed on one or more flying platforms. One general solution is to use a distributed solution using orchestrators, millimetric waves (mmWave), laser, beamforming and multiple input-multiple output (MIMO) technologies.

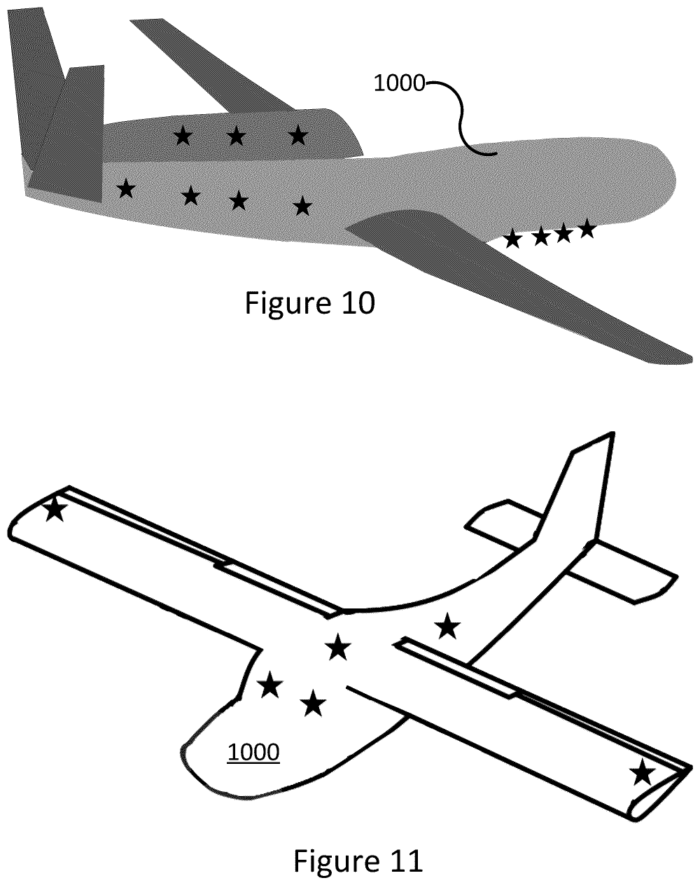

On FIG. 1, an example of a flying platform 1000 is depicted as an airship presenting a convex frontend 1200 and a concave backend 1100. As skilled persons will readily recognize, various types of flying platforms may be used in the context of the teachings presented herein. While FIGS. 10, 11 and 13 present some examples of such variations, many other may be made without departing from the teachings of the present disclosure.

The example of FIG. 1 will be used to discuss some embodiments of related to the present disclosure. A channel 1300 may optionally be provided between the frontend 1200 and the backend 1100. The flying platform 1000 defines an internal space 1400 therewithin. One or more pockets (not shown) within the internal space are typically filled with lighter-than-air gas to provide positive air buoyancy to the flying platform 1000. The pockets may be interconnected and/or may contain different gas, including air and/or heavier-than-air gas to support different flying configurations of the platform 1000. As persons skilled in the art will recognize, different manners of organizing the pocket(s) to provide buoyancy to the flying platform 1000 may be used without affecting the teachings presented herein.

The channel 1300 may provide a frontend attachment mechanism 1320 and a backend attachment mechanism 1310. In the depicted example, the front end 1200 and backend 1100 are compatibly shaped such that, when another flying platform 1000′ approaches the flying platform 1000, the frontend attachment mechanism 1320′ thereof mates with the backend attachment mechanism 1310 to secure a connection between the flying platforms 1000 and 1000′ (e.g., using an electromechanical lock and/or an electromagnetic lock). In some embodiments, an interconnector (not shown) may be used between the attachment mechanisms 1320′, 1310. In other embodiments, the backend 1100 of the flying platform and the frontend 1200′ of the flying platform 1000′ may be attached to one another (e.g., using an extendable mechanism from the channel 1300, which may be useful for air or flight behavior characteristics). In some embodiments, alternate attachment positions may be additionally or alternatively defined by one or more attachment points 1310′, 1310″, optionally presenting a mating surface 1100′, 1100″.

Antennas 210 are depicted selectively positioned on an external surface of the flying platform 1000 and/or within the internal volume 1400. Additionally or alternatively, antennas 210 may further be selectively positioned on the internal surface (not shown) within the flying platform 1000 (e.g., when more than one surface shells are provided). As such, skilled persons will recognize that antennas of one or more kinds may be deployed, and that the deployment may be performed having antennas 210 on the surface flying platform 1000 (i.e., inside or outside) with or without antennas 210 being deployed in the internal volume 1400 or that antennas 210 may only be deployed in the internal volume 1400. Hexagons and stars are used to illustrate antennas 210 in the figures in an effort to exemplify that different antennas of different shapes may be used without affecting the teachings presented herein. Skilled persons will readily understand that the actual shape of antennas is not bound by the selected depictions.

A clipping mechanism (not shown) is proposed to selectively position one or more antennas 210 on the exterior surface and/or inside the flying platform 1000. The clipping mechanism may provide a permanent or define a detachably-attachable interface between the antennas 210 and the flying platform 1000. In some embodiments, one or more of the antennas 210 may have autonomous mobility (e.g., FIG. 13 may represent a single antenna 210 or a group of antennas 210 rather than antenna(s) 210 on a flying platform 1000) and may therefore be selectively deployed. Antennas 210 deployed on multiple flying platforms 1000 may also be used to enhance the capabilities of a group of flying platforms (e.g., 1000; 1000′), expanding potential for, e.g., filling all the signals 220 (e.g., 5G) in the air with multiple layers of NTN (Non-Terrestrial Network).

In some embodiments, antennas 210 may take shapes of one or more portions of the surface of the flying platform or the whole of the flying platform surface. The surface of the flying platform or the portions thereof may be morphed dynamically, which may provide extra flexibility and adaptability in enhancing antenna performance.

In one set of embodiments, and as an illustrative example, one or more cylindrical form factor antennas, to be integrated within the structure of the flying platform 1000, are used in the design of flying platforms 1000. While other shape may very well be used, examples of advantages expected from cylindrical form factor include enhanced coverage and beamforming capabilities, enabling efficient signal propagation across a wide range of angles and a more comprehensive coverage footprint, ensuring reliable connectivity in all directions. In another set of embodiments, the surface of the flying platform is configured to be planar and may further be dynamically selectively adapted to provide other shapes including but not limited to surface morphing/modification techniques. Those other shapes may be selected for aerospace behavior and, alternatively or additionally, may also be selected to modify electromagnetic properties of the flying platform 1000. For instance, the planar shape may be modified towards a convex shape when reaching a certain attitude (e.g., to enhance inter-platforms communication on different altitude levels) and/or the planar shape may be adapted to a concave shape (e.g., to provide more coverage to ground).

Having an increased antenna 210 density on or within the flying platform 1000, allowing for a larger number of antennas 210 to be selectively positioned may be advantageous. While the cylindrical form factor is expected to allow such an increased density of antennas 210, skilled persons will recognize that other shapes may be used for the same purpose. The antennas 210 are depicted emitting signals or beams 220. As skilled persons will readily understand, the depiction of the beam 220 is meant to illustrate the capability of the antennas 210 and not necessarily the characteristics of the beam 220 itself. The increased antenna 210 density is expected to enhance overall capacity and throughput of the flying platform 1000, supporting a higher number of concurrent users and enabling the delivery of bandwidth-intensive services. A gimbal/outer shell/inner shell configuration may be deployed to enhance physical positioning of the antennas 210, e.g., with the ability to move the antennas 210 on multiple superposing layers on the flying platform 1000 surface, which may further be rotatable in 3D, in additional to 3D tilting of the antennas 210 themselves.

A distributed antenna system is a network of antennas that are selectively positioned throughout a specific area to enhance wireless coverage and capacity. A

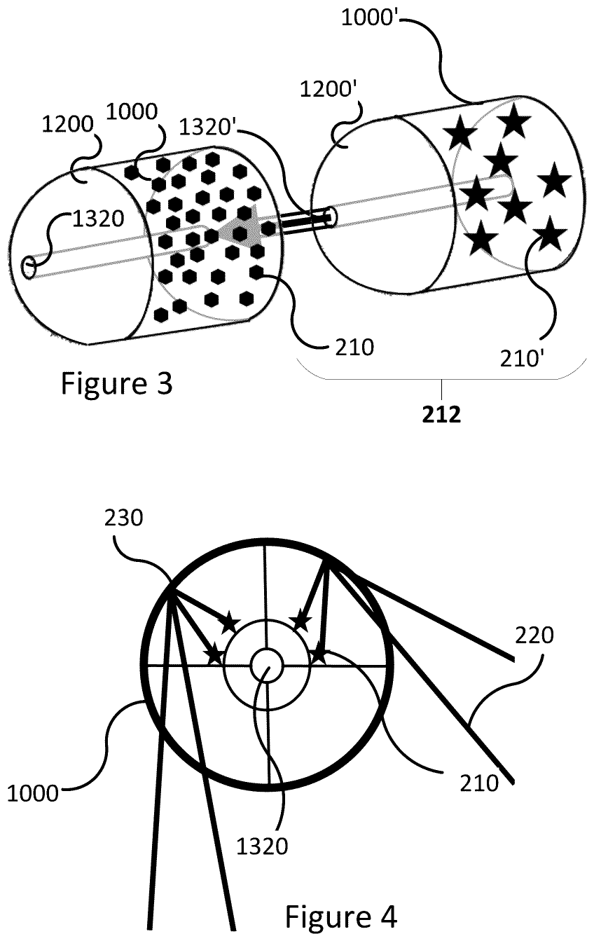

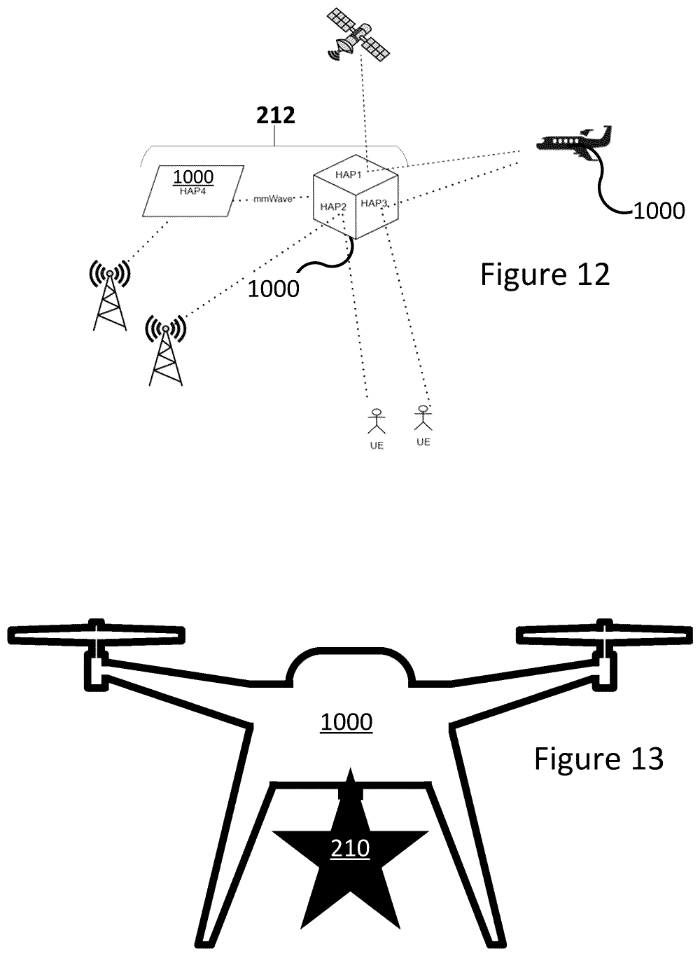

DAS is expected to improve coverage, reducing outage on the downlink, reducing outage on the uplink, and increasing capacity. With reference to the examples of FIG. 3 and FIG. 12, a DAS 212 may be provided by configuring the antennas 210 and 210′ from different flying platforms 1000 (e.g., from various configurations of joined or connected and/or standalone flying platforms). In some examples of DAS deployment, individual remote radio units (RRUs) may have minimal intelligence of their own. The DAS 212 may be seen, from a structural perspective, as an extension of the base station antenna 210 ports. A DAS 212 may further work with different multiple access technologies and may also work with laser, mmWave, fiber cable, etc.

For instance, the DAS 212 may be deployed with MIMO where simultaneous transmission to (on the downlink) or reception from (on the uplink) multiple network nodes (e.g., other flying platforms 1000 and/or users) increases the sum rate with one or multiple flying platforms 1000 being involved. The antennas 210 system may be configured to tilt a transmit beam 220 angle in full 3D space for improving the overall system throughput and interference management, especially for scenarios where mobile users are distributed in a 3D space with distinguishable elevation such as modern urban environments. The latter case is expected to become increasingly important with the prevalence of the small cell concept, in which the horizontal scale becomes more comparable with the vertical scale.

A DAS 212 may also, alternatively or additionally, be deployed with mmWave. To ensure tight synchronization and scalability, a mmWave-over-fiber based architecture may be used with low-complexity high-performance radio antenna units (RAUS).

A DAS 212 may also, alternatively or additionally, be deployed with other technologies, such as laser. The DAS 212 may deliver wireless signals transferred from the mobile front-haul throughout the networked environment via the host equipment and the distribution network which includes fiber optic cables, fiber distribution units (e.g. optical splitters), and the radio antenna units (RAU).

Embodiments disclosed herein propose to deploy one or more dynamic intelligent reflection surfaces (IRS) 230 (e.g., to modify and/or create additional links, and expectedly, enhance the performance). A large number of reconfigurable passive elements are deployed using IRS 230, which is configured to controllably and selectively reflect the incident signals 220 e.g., via adjusting the phase shifts and/or granularly controlling positioning (e.g., relative orientation) of one or more discrete surface elements of a reflective space 230 of on the surface). As a result, and as an example, when there is no direct link between a transmitter and a receiver, communication may still be realized via building a reflective link with the help of the IRS 230. As such, incorporating MIMO and IRS 230 into communication may effectively enhance the signal reception and reduce the probability of signal blockage. The IRS 230 is expected to bring advantages especially in a 3D environment where flying platforms (Unmanned vehicle, HAP, . . . ), and satellites can collaborate together to bring enhanced coverage and network performance.

An exemplary focus of embodiments described herein is on providing a 3D distributed, flexible 3D MIMO antenna and 3D IRS system 230 with an orchestration mechanism to enable a distributed architecture.

In certain embodiments, a flying platform 1000 may transport as a payload another flying base station 240. The secondary flying platform 240 may be identical in size and characteristics (e.g., when a modular structure is used therein), but may also be different (e.g., a smaller flying platform 240 having a more limited number of capabilities). Buoyancy of the flying platform 240 may be providing by expanding compressed gas (e.g., from one or more bottles from a payload of the flying platform 1000 or another flying platform 1000′).

The flying base station 240 can be deployed tethered 230 and/or untethered 250 (e.g., through wired/wireless communication and wired/wireless charging). The flying base station 240 may dispose of one or more of propelling, sensing, communication and reflection functions and may contribute to enhanced communication and sensing capabilities of a group or cluster of flying platforms 1000.

Distributed, flexible and intelligent-beamforming 3D MIMO antennas (distributed, 3D MIMO, flexible or dynamic)

A wired or wireless communication system employs multiple antennas 210 distributed on the air to enhance performance and capacity. These antennas 210 are capable of operating in three dimensions (3D) and can dynamically adapt their configuration to optimize the transmission and reception of signals 220. The concept of 3D MIMO antennas 210 is extended to a distributed system where multiple Remote Antenna Units (RAUs) (e.g., on a dedicated flying platform 1000 or 240) are deployed from or on flying platforms 1000 (e.g., High Altitude Platforms (HAPs). The distributed system consists of the RAUs (e.g., 240 or on another flying platform 1000) that are selectively positioned at different computed locations within the coverage area. Once positioned (e.g., on or in the flying platform 1000, tethered, autonomous positioning, using clipping mechanism, etc.), the RAUs 240 can be connected using various mechanisms, as skilled persons will readily recognize. For instance, the RAUs 240 may be physically clipped together to form a cohesive array. The clipping mechanism is configured to ensure that the individual antennas 210 are capable of configurably forming a high-gain, beamforming antenna system. Alternatively or additionally, the RAUs 240 may be connected wirelessly using communication technologies such as millimeter-wave (mmWave) or laser links. The wireless connectivity 250 may provide enhanced flexibility of deployment and interconnection of the RAUs 240, even when physical cabling is not feasible or practical.

A distributed 3D MIMO system with its flexible and adaptive configuration may offer several advantages. For instance, in some deployments, it may enable improved coverage, capacity, and spectral efficiency by leveraging the distributed deployment of antennas 210, dynamic beamforming, and resource optimization. The 3D MIMO aspect may further allow for additional antenna elements 210 in the vertical dimension, further enhancing system performance.

Additionally, the distributed system on flying platforms 1000 may offer additional advantages such as increased coverage range, reduced infrastructure costs, improved spectrum efficiency, increase network capacity and improved flexibility in deployment compared to traditional ground-based systems. A group of antennas 212 on flying platforms 1000 may collaborate with others to enable a virtual array antenna 212 with different sizes, capacity, and coverage angles.

Using a distributed and flexible active 3D MIMO antenna system, wireless communication systems may be configured to overcome coverage limitations, mitigate interference, and provide seamless connectivity. The adaptability and dynamic configuration of these antennas 210 may further contribute to improved performance, higher data rates, and enhanced user experience in various applications such as 5G networks, Internet of Things (IOT), and wireless communication in challenging environments.

As such, embodiments presented herein allow for a three-dimensional network infrastructure in the air may to be deployed. Leveraging advanced beamforming techniques, intelligent footprint coverage may be provided on the ground and in the aerial domain, contributing to seamless signal propagation (e.g., 5G) throughout the entire three-dimensional environment. Furthermore, the maximum number of beams 220 from a single or multiple flying platforms 1000 may be enhanced by orchestrating the beamforming and resource allocation on the flying platforms 1000.

Strategic and selective clustering 212 of multiple antennas 210 deployed across different flying platforms 1000. The antenna 210 systems are arranged to establish dynamic and optimal beams 220 that are configured for precise vectorial deployment, effectively filling every blind signal space within the 3D environment.

Through adaptive beamforming, transmission and reception of signals 220 may be selectively steered, allowing for enhanced utilization of radio resources and targeted coverage expansion. By dynamically adjusting one or more beam parameters (e.g., the number of beams 220 (1 to many), their collective or individual direction, their collective or individual size and/or shape), delivery of signals (e.g., 5G) may be enhanced even towards the most challenging locations, including areas with obstructed line-of-sight or unique architectural structures.

A 3D MIMO implementation has the potential to substantially enhance network coverage, extending beyond the traditional ground-based infrastructure to offer seamless connectivity in the air. By leveraging the power of beamforming and clustering techniques, signal penetration (e.g., 5G) is expected to be significantly improved, enabling enhanced user experiences and unlocking the full potential of the three-dimensional wireless ecosystem.

Embodiments described herein also provide multiple interfaces for distributed and mobile 3D MIMO antennas (multiple interfaces, 3D MIMO, distributed and mobility)

The flying platform 1000 may be designed to support multiple interfaces, including copper, fiber, millimeter-wave (mmWave), or laser links to facilitate the interconnection and communication 250 among the distributed RAUs 212 within the flying platform 1000 system comprising, among other elements, multiple flying platforms 1000.

With the support for various interfaces, the flying platform 1000 system may establish multiple 3D MIMO with heterogeneous antenna shapes for different purposes on the air, creating a network of antennas that serve different layers of the Non-Terrestrial Network (NTN), which is expected to comprise various entities such as ground User Equipment (UEs), ground Base Stations (BSs), drones, Unmanned Aerial Vehicles (UAVs), HAPs, and satellites.

The distributed RAUs 212, connected via the supported interfaces, may form a coordinated system of 3D MIMO antennas in the sky. The antenna 210 system may be selectively positioned to cater to the diverse communication needs of the NTN heterogeneous networks. Each layer of the network, including ground UEs, ground BSs, drones, UAVs, HAPs, and satellites, may be served by dedicated or overlapping 3D MIMO antenna configurations.

The ground UEs may benefit from the improved coverage, capacity, and data rates provided by the 3D MIMO antennas. The ground base stations may further enhance their communication capabilities by leveraging the advanced beamforming and interference mitigation capabilities of the 3D MIMO system. The flying platform 1100 (e.g., drones, UAVs, . . . ) may establish reliable and high-speed connections with the ground and other network entities using the distributed 3D MIMO antennas 210. The flying platforms 1000 themselves may utilize the antennas 210 for inter-platform communication and connectivity with other network layers. In some embodiments, satellites (not shown) may be integrated into the network, benefiting from the coverage extension and enhanced communication links offered by the 3D MIMO antennas.

A distributed 3D MIMO system deployed on flying platforms 1000 may bring several advantages to the NTN heterogeneous networks. For instance, it may enable seamless connectivity, efficient resource utilization, and improved network performance across different layers of the network. The support for multiple interfaces is expected to enhance flexibility and adaptability in establishing connections between the distributed RAUs 212, allowing for scalable and versatile network deployments.

Embodiments presented herein also provide dynamic and mobile 3D intelligent reflection surfaces (dynamic or flexible, mobility, 3D IRS 230).

Intelligent Reflection Surfaces (IRS) 230 may be incorporated into multiple flying platforms 1000, or even flying base stations 240, to enhance capabilities and flexibility.

By connecting together multiple collaborating flying platforms 1000, a dynamic and adaptable 3D virtual reflection surface may be created in the air. The intelligent reflective surface 230 may be configured to act as a MIMO intelligent reflection surface for reflecting signals 220 from satellites, the ground or other flying platforms 1000 to desired locations on the ground or in the air, catering to the specific requirements.

In order to support more complex configurations of flying platform assembly, nodal flying platforms may be provided for enabling lateral connections. The number of flying platforms 1000 that may be connected may vary depending on the design of the nodal flying platform. By varying the angle of the interface ring between the flying platforms, a while range of angles may be supported between two fixed positions.

Examples of advantages may include automatically adjusting and configuring the 3D IRS 230 based on user requirements not only on the ground but also on the air. By leveraging intelligent algorithms and advanced communication protocols, the flying platforms 1000; 1000′ may dynamically align and coordinate themselves to form an enhanced reflection surface for a given scenario. The adaptability enhances efficiency of signal reflection and may further enable tailored coverage for different applications, such as providing connectivity in remote areas, disaster response scenarios, or even airborne communication needs.

Collaboration between multiple flying platforms 1000 or flying base stations 240 may further introduce a new level of scalability and coverage. By expanding the network and adding more flying platforms 1000, a larger number of users may be accommodated, extending coverage to underserved regions, and enhancing overall communication capacity. Scalability may be particularly beneficial for situations requiring rapid deployment or temporary communication infrastructure, such as emergency response operations or large-scale events.

Power efficiency and regulatory compliance may also be enhanced. For instance, energy consumption may be enhanced while ensuring a stable power supply for the flying platforms 1000. Regulatory bodies and stakeholders may also benefit from coordinated and uniform airspace usage, spectrum licensing, and frequency allocation. Compliance with regulations is expected to play a key role in enabling seamless and legally compliant operation of the 3D IRS 230 system.

Distributed 3D MIMO and 3D IRS (Intelligent Reflecting Surfaces) 2230 may further be enhanced by using tethered platforms 240. A distributed architecture may be deployed with tethered platforms 240. Coordination and cooperation among multiple flying platforms 1000 may allow formation of a distributed antenna system where multiple antennas 210 on flying platforms 1000 can clip together to establish different shapes for many purposes of coverage. Even when the base band unit is not being carried, flying platforms 1000 may still be configured to carry remote radio units on the air to establish the 3D MIMO antenna system. The tethered platforms 240 may then transfer energy 250 from ground to other flying platforms 1000 and may further transfer signal to the air. Algorithms and protocols may be provided for joint beamforming, power control, and resource allocation across the tethered platforms 240.

3D IRS 230 technology may also be deployed in the context of the 3D MIMO system deployed on tethered platforms 240. Optimization of beamforming, power control, and intelligent reflection 230 for enhanced performance may be combined in order for the IRS 230 elements and the distributed antenna system 240 to increase capacity, coverage, and energy efficiency.

Joint Energy and Mobility Management in Distributed 3D MIMO HAP Networks may also be provided.

Different mechanisms may be deployed to provide transfer energy from ground-to-flying platform 250 and flying platform-to-flying platform 250, e.g., using tether 230, mmWave 250 and/or laser interface 250. A flying platform-controller may use different technologies such as wireless power transfer (WPT) via tethered 230 connections, microwave power transfer using mmWave frequencies 250, and laser-based power transfer 250 in order to manage and enhance energy management in one or more flying platforms

When mobility management is further considered, flying platforms 1000 displacements may be enhanced to clip with other flying platforms 1000 in order to enhance energy transfer. Energy and mobility management may also be considered when clipping multiple flying platforms 1000; 1000′ in order to establish a distributed 3D MIMO on the air in terms of energy efficiency.

Orchestration of distributed IRS 230 and flexible 3D MIMO antennas (orchestration or clustering, distributed, flexible or dynamic, IRS, 3D MIMO)

An orchestration mechanism may be deployed for efficiently controlling, managing, and facilitating seamless collaboration among distributed Intelligent Reflecting Surfaces (IRSs) 230 and Multiple-Input Multiple-Output (MIMO) antennas 210 deployed across different flying platforms 1000. An advanced orchestration framework may be provided to allow for establishment of diverse shapes and configurations of IRSs 230 and 3D MIMO antennas 210, enabling customization considering unique clipping shape of each flying platform 1000 and/or leveraging cutting-edge wireless communication technologies 250 like laser or millimeter-wave (mmWave).

By leveraging the orchestration mechanism, limitations imposed by a single flying platform 1000 deployment are minimized while still enhancing coverage performance and minimizing operational costs associated with deploying multiple flying platforms 1000; 1000′. The orchestration mechanism's ability to integrate and coordinate the distributed IRSs 230 and MIMO antennas 210 is expected to provide a synergistic combination that enhances overall network coverage and performance.

Within an embodiment, the antenna modules 210 or their supporting flying platform 1000 can be joined physically through a clipping mechanism to enhance the distributed 3D MIMO in contexts where physical attachment enhances performance and stability of the system. Physical positioning (e.g., clipping) may be performed in 2D (linear clipping), in 3D configuration (clipping in 3 axis) or aggregated clipping (such as spherical clipping). Energy necessary for spatially organizing distribution (clipping) may be provided by a tethered 230 or untethered way (e.g., from the flying platform 1000 or the ground).

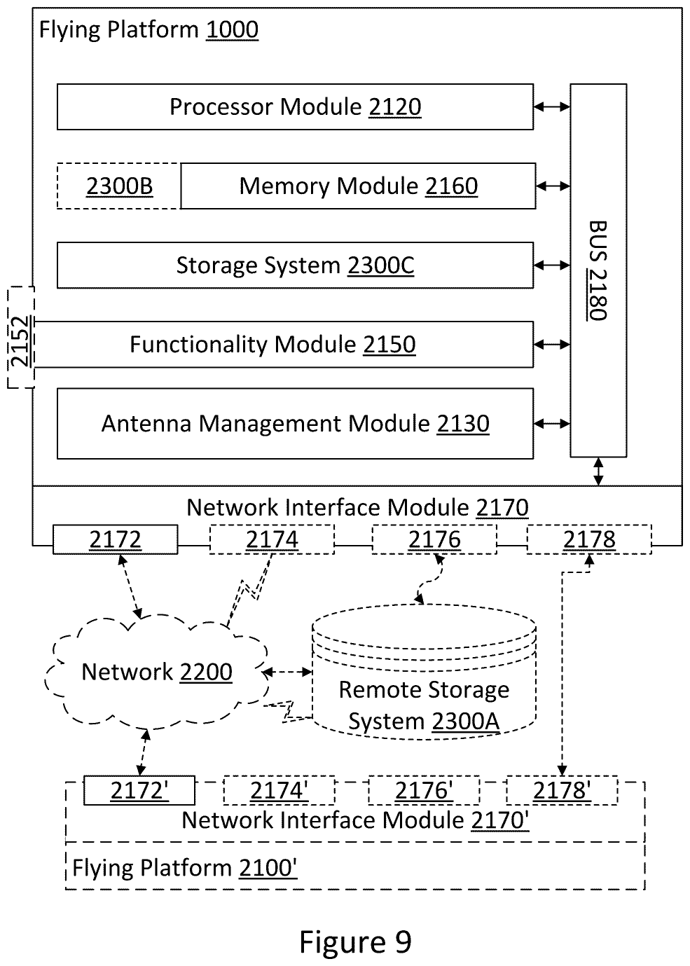

FIG. 9 shows a logical modular representation of an exemplary system comprising a flying platform 2100. Skilled persons will recognize that the flying platform 2100 depicted on FIG. 9 may correspond to the flying platform 1000 as well as the flying base station 240. The flying platform 2100 comprises a memory module 2160, a processor module 2120, an antenna management module 2130 and a network interface module 2170. The modular flying platform 2100 may also include a functionality module 2150.

The system may comprise a storage system 2300 for storing and accessing long-term (i.e., non-transitory) data and may further log data while the modular flying platform 2100 is being used. FIG. 9 shows examples of the storage system 2300 as a distinct database system 2300A, a distinct module 2300C of the modular flying platform 2100 or a sub-module 2300B of the memory module 2160 of the modular flying platform 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the modular flying platform 2100 by a standardized or proprietary interface or via the network interface module 2170.

The network interface module 2170 represents at least one physical interface that can be used to communicate with other modular flying platforms. The network interface module 2170 may be made visible to the other modules of the modular flying platform 2100 through one or more logical interfaces. The actual stacks of protocols used by the physical network interface(s) and/or logical network interface(s) 2172-2178 of the network interface module 2170 do not affect the teachings of the present invention.

The processor module 2120 may represent a single processor with one or more processor cores or an array of processors, each comprising one or more processor cores. The memory module 2160 may comprise various types of memory (different standardized or kinds of Random Access Memory (RAM) modules, memory cards, Read-Only Memory (ROM) modules, programmable ROM, etc.).

A bus 2180 is depicted as an example of means for exchanging data between the different modules of the modular flying platform 2100. The teachings presented herein are not affected by the way the different modules exchange information. For instance, the memory module 2160 and the processor module 2120 could be connected by a parallel bus, but could also be connected by a serial connection or involve an intermediate module (not shown) without affecting the teachings of the present invention.

An antenna management module 2130 provides antenna management-related services to the modular flying platform 2100.

The variants of processor module 2120, memory module 2160 and network interface module 2170 usable in the context of the present invention will be readily apparent to persons skilled in the art. Likewise, even though explicit mentions of the antenna management module 2130, the memory module 2160, the functionality module 2150 and/or the processor module 2120 are not made throughout the description of the present examples, persons skilled in the art will readily recognize when such modules are used in conjunction with other modules of the modular flying platform 2100 to perform routine as well as innovative elements presented herein.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art.

The embodiments were chosen to explain the principles of the invention and its practical applications and to enable others of ordinary skill in the art to understand the invention in order to implement various embodiments with various modifications as might be suited to other contemplated uses.

What is claimed is:

1. A distributed antenna system for flying platforms, comprising:
a plurality of flying platforms;
a plurality of antennas; and
an orchestration mechanism for dynamically positioning the one or more antennas on the plurality of flying platforms.

2. The distributed antenna system of claim 1, wherein the orchestration mechanism further dynamically positions the one or more antennas by:
determining a position for each of the one or more antennas, the position being determined relative to one of the plurality of flying platforms; and
determining relative positions between the plurality of flying platforms.

3. The distributed antenna system of claim 2, wherein the orchestration mechanism further determines, upon trigger, a new composition for the plurality of flying platforms, redetermines the position for each of the one or more antennas, the position being determined relative to one of the plurality of flying platforms and redetermines the relative positions between the plurality of flying platforms.

4. The distributed antenna system of claim 2, wherein the one or more antennas are selectively positioned on an external surface thereof and/or within an internal volume of the plurality of flying platforms.

5. The distributed antenna system of claim 2, wherein one or more intelligent reflection surfaces (IRS) are deployed on one or more of the plurality of flying platforms and wherein the orchestration mechanism further determines at least one of the position of the one or more antennas and the relative positions between the plurality of flying platforms considering the one or more IRS.

6. The distributed antenna system of claim 5, wherein the IRS are selectively positioned on an external surface and/or within an internal volume thereof.

7. The distributed antenna system of claim 1, wherein the antennas are configured for one or more of millimeter-wave (mmWave) communication, laser communication, and multiple input-multiple output (MIMO) communication.

8. The distributed antenna system of claim 1, wherein the orchestration mechanism dynamically positions the one or more antennas on the plurality of flying platforms to configure a distributed 3D MIMO antenna system.

9. The distributed antenna system of claim 1, wherein each of the flying platforms further comprises a frontend attachment mechanism and a backend attachment mechanism for securing connections therebetween, wherein a channel is formed between connected flying platforms.

10. A flying platform for a distributed antenna system, comprising:
an internal space comprising one or more internal pockets filled with lighter-than-air gas;
an external surface;
one or more antennas;
a clipping mechanism for selectively positioning the one or more antennas within the internal space and/or on the external surface.

11. The flying platform of claim 10, further comprising one or more intelligent reflection surfaces (IRS), an orchestration mechanism further determining the position of the one or more antennas considering the one or more IRS.

12. The flying platform of claim 10, wherein the antennas are configured for one or more of millimeter-wave (mmWave) communication, laser communication, beamforming and multiple input-multiple output (MIMO) communication.

13. The flying platform of claim 10, further comprising a frontend attachment mechanism and a backend attachment mechanism for securing connections with other flying platforms, a channel being formed between connected flying platforms.

14. A method for enhancing wireless communication in a distributed antenna system on flying platforms, comprising:
selectively positioning multiple antennas on a plurality of flying platforms;
upon trigger, dynamically repositioning the one or more antennas on the plurality of flying platforms considering transmission and reception of signals thereby.

15. The method of claim 14 further comprising dynamically repositioning the one or more antennas by:
determining a position for each of the one or more antennas, the position being determined relative to one of the plurality of flying platforms; and
determining relative positions between the plurality of flying platforms.

16. The method of claim 15, further comprising, upon trigger, determining a new composition for the plurality of flying platforms, redetermining the position for each of the one or more antennas, the position being determined relative to one of the plurality of flying platforms and redetermining the relative positions between the plurality of flying platforms.

17. The method of claim 14, further comprising configuring the antennas for one or more of millimeter-wave (mmWave) communication, beamforming, laser communication and multiple input-multiple output (MIMO) communication.
